(19) United States
(12) Patent Application Publication
(10) Pub. No.: US 2024/0280813 A1
(43) Pub. Date: Aug. 22, 2024

(54) Augmented Reality Devices with Passive Neural Network Computation

(71) Applicant: Micron Technology, Inc., Boise, ID (US)

(72) Inventors: Saideep Tiku, Folsom, CA (US); Shashank Bangalore Lakshman, Folsom, CA (US); Poorna Kale, Folsom, CA (US)

(21) Appl. No.: 18/415,256

(22) Filed: Jan. 17, 2024

Related U.S. Application Data
(60) Provisional application No. 63/485,474, filed on Feb. 16, 2023.

(51) Int. Cl. G02B 27/01; G06T 19/00; G06V 10/82

(52) U.S. Cl. CPC G02B 27/017; G02B 27/0101; G06T 19/006; G06V 10/82; G02B 2027/0178

(57) ABSTRACT

An augmented reality device having a pair of glasses and an artificial neural network partially implemented via a passive neural network and partially implemented via digital circuits. The passive neural network can process image lights representative of a scene in a view of the pair of glasses to generate a light pattern. An array of light sensing pixels can convert the light pattern into data representative of outputs of a first set of artificial neurons of the artificial neural network. A processor can execute instructions to perform computations of a second set of artificial neurons of the artificial neural network responsive to the outputs of the first set of artificial neurons. A digital accelerator can accelerate multiplication and accumulation operations applied on weight matrices of the second set of artificial neurons.

### RELATED APPLICATIONS

The present application claims priority to Prov. U.S. Pat. App. Ser. No. 63/485,474 filed Feb. 16, 2023, the entire disclosures of which application are hereby incorporated herein by reference.

### TECHNICAL FIELD

At least some embodiments disclosed herein relate to computations of multiplication and accumulation in image processing in general and more particularly, but not limited to, reduction of energy usage in computations implemented in augmented reality devices, such as smart glasses.

### BACKGROUND

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in the electrical domain.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates a pair of augmented reality glasses having a computing unit configured according to one embodiment.

FIG. 2 shows a computing unit having a passive neural network and a digital multiplication and accumulation accelerator configured according to one embodiment.

FIG. 3 illustrates the processing of an image using a passive neural network configured according to one embodiment.

FIG. 4 shows a processing unit configured to perform matrix-matrix operations according to one embodiment.

FIG. 5 shows a processing unit configured to perform matrix-vector operations according to one embodiment.

FIG. 6 shows a processing unit configured to perform vector-vector operations according to one embodiment.

FIG. 7 shows a method of augmented reality according to one embodiment.

### DETAILED DESCRIPTION

At least some embodiments disclosed herein provide techniques of reducing the energy expenditure in computations of multiplication and accumulation in augmented reality applications.

An augmented reality device, such as a pair of smart glasses, can be configured to use an artificial neural network to analyze an image of a scene, detect and recognize objects of interest in the scene, and provide information about the recognized objects to the user of the device. Such a device configured to be worn on a person (e.g., as a pair of glasses) typically has space constraints that limit the configuration of energy, weight, and computing power in the device.

There are recent advances in passive neural networks that implement computations of artificial neural networks using meta neurons in the form of units or cells of photonic/phononic crystals and metamaterials. Such meta neurons can manipulate wave propagation properties in refraction, reflection, invisibility, rectification, scattering, etc. in ways corresponding to the computations of artificial neural networks.

For example, a passive neural network can be implemented via diffractive layers with local thicknesses configured according to the result of machine learning of an artificial neural network. For example, multiple layers of meta neurons can be used to interact with and scatter a wave rebounded from an object to passively perform the computations of a trained artificial neural network.

The energy in the received waves powers their further propagation through the meta neurons in a way corresponding to the computations of the artificial neural networks. Thus, no additional energy input is required for the passive neural networks to process the input waves in generating the outputs of the passive neural networks.

In at least some embodiments, a passive neural network is configured in an augmented reality device to process an image input to perform feature extraction and filtering with reduced or minimized energy consumption. When the input image with an object of interest is detected via the passive neural network, logic circuits in the augmented reality device can be powered up (e.g., via a battery pack) to further process the feature data generated by the passive neural network.

For example, an artificial neural network trained for an augmented reality device can have multiple layers of artificial neurons in processing an image, detecting an object in the image, and classifying or recognizing the object. A subset of initial layers of the artificial neural network can be implemented via a passive neural network and configured to generate a classification of whether to further process the image using the subsequent layers. The subsequent layers can be implemented via digital components and accelerated using a digital multiplication and accumulation accelerator. The functionality and the accuracy of the subsequent layers can be customizable for specific applications of interest to the user, and can be upgraded. Thus, the usability, feature, accuracy, and energy performance of the augmented reality device can be balanced via the split implementation of the artificial neural network using a hardwired passive neural network and a flexible, reprogrammable, digital implementation of artificial neurons.

Such an arrangement can alleviate the computational and energy burden on the battery powered digital components within the augmented reality device. Since the passive neural network does not drain the battery pack in performing the filtering and feature extraction, the energy performance of the augmented reality device is improved. The digital components configured in the augmented reality device can further perform computations of an artificial neural network, based on the outputs of the passive neural network. Thus, the functionality and accuracy of the augmented reality device can be improved beyond what can be hardwired into the passive neural network.

The techniques can also be used in other types of devices involving monitoring and processing images, such as drones, unmanned aerial vehicles (UAV), surveillance cameras, etc.

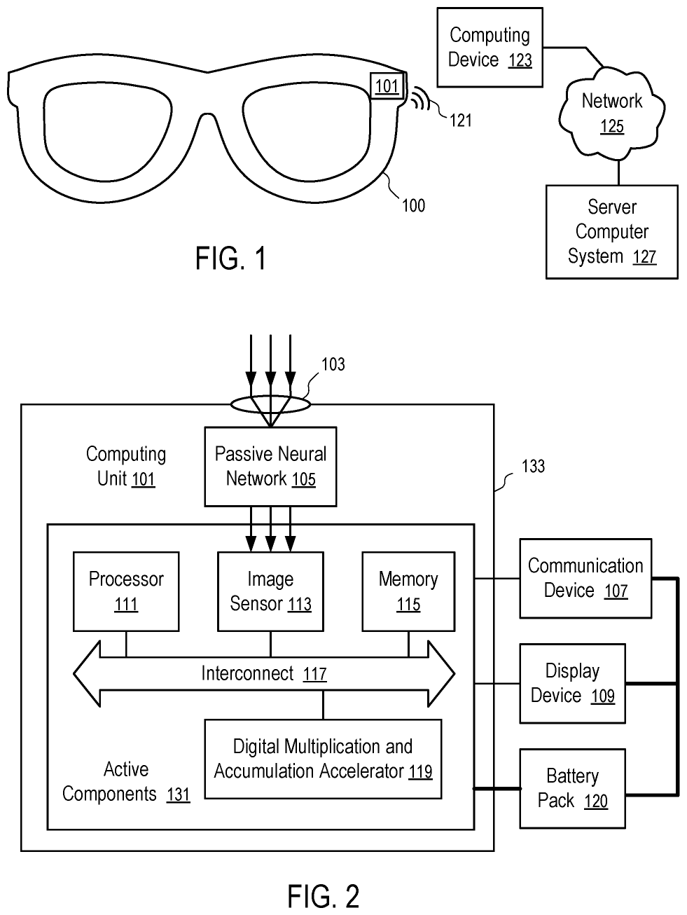

FIG. 1 illustrates a pair of augmented reality glasses 100 having a computing unit 101 configured according to one embodiment.

For example, the computing unit 101 can analyze the scene in the field of view of the glasses 100 using an artificial neural network, identify or recognize an object in the scene, and provide information about the object via the glasses 100,

For example, the information about the object can be presented to the user via overlaying the information on the glasses, or via projection of the information into an eye of the user wearing the glasses 100. Optionally, or alternatively, the information can be presented via audio signals transmitted via headphones or speakers configured on, or connected to, the glasses 100.

In some implementations, the computing unit 101 can communicate with a nearby computing device 123, such as a mobile phone, a laptop computer, a personal computer, over a wireless connection 121 to a personal area network (e.g., using a bluetooth connection) or a local area network (e.g., using a wifi connection). For example, the computing device 123 can be configured to perform a portion of the computations in identifying and/or obtaining the information for the augmented reality application.

Optionally, the computing unit 101 can provide input data about the scene to the computing device 123 and request the computing device 123 to identify or recognize an object and provide the information about the object.

Alternatively, or in combination, the computing unit 101 and/or the computing device 123 can be configured to further communicate, over a computer network 125 (e.g., internet or a telecommunications network) with a remote server computer system 127 to identify and/or obtain the information. The computing tasks for augmented reality applications can be distributed across the computing unit 101, the computing device 123, and the server computer system 127.

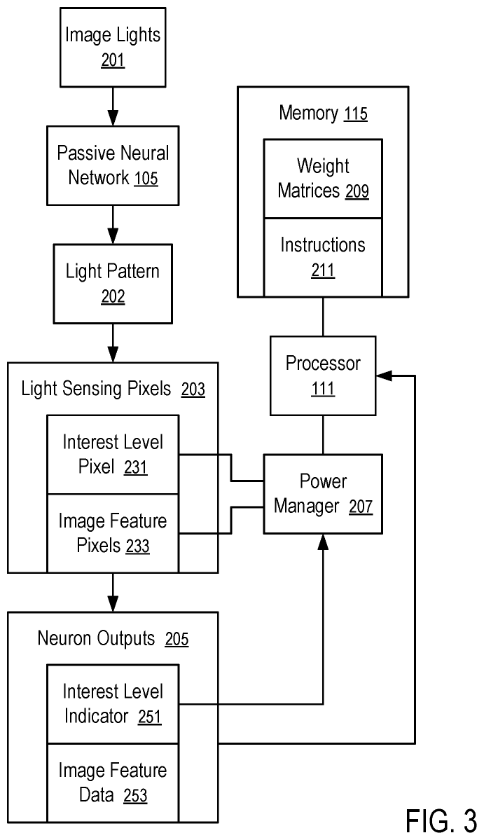

The computing unit 101 can be powered via a battery pack configured on the glasses 100. To reduce energy consumption and improve battery performance, at least a portion of the computations of the artificial neural network is implemented via a passive neural network, as further discussed in connection with FIG. 2 and FIG. 3.

FIG. 2 shows a computing unit 101 having a passive neural network 105 and a digital multiplication and accumulation accelerator 119 configured according to one embodiment. For example, the computing unit 101 in the augmented reality glasses 100 of FIG. 1 can be implemented in a way as shown in FIG. 2.

In FIG. 2, an image generating device 103 (e.g., a lens) can be used to direct an image onto a passive neural network 105. The analysis of the image can be performed via an artificial neural network implemented via a combination of the passive neural network 105 and active components 131.

The passive neural network 105 has layers of meta neurons in the form of units or cells of photonic/phononic crystals and metamaterials manufactured with light wave manipulating properties corresponding to the attributes of a set of artificial neurons of the artificial neural network trained to detect and recognize objects in the images from the image generating device 103.

The active components 131 of the computing unit 101 can include a processor 111 configured to execute instructions, a memory 115 configured to store the instructions and data to be used by the instructions, and a digital multiplication and accumulation accelerator 119. An interconnect 117 connects the processor 111, the memory 115, the digital multiplication and accumulation accelerator 119, and an image sensor 113 configured to convert the processing results of the passive neural network 105 from an analog form of light patterns, to a digital form of data to be further processed by the processor 111.

For example, the artificial neural network can be trained to analyze an image of a scene and identify or recognize an object in the scene. The artificial neural network can include a first portion configured to filter and extract features in the image and thus reduce the size of data to be further analyzed in a second portion of the artificial neural network.

The feature extraction portion of the artificial neural network can be implemented via the passive neural network 105; and the object identification/classification portion of the artificial neural network can be implemented via software executed in the processor 111 using weight matrices of the artificial neurons stored in the memory 115. The processor 111 can use the accelerator 119 to accelerate the computations of multiplication and accumulation involving the weight matrices.

Optionally, the computing unit 101 is configured in an integrated circuit device. An integrated circuit package 133 is configured to enclose the meta neurons of the passive neural network 105 and the active components 131. Alternatively, one or more of the active components 131 (e.g., the processor 111, the memory 115, or the accelerator 119, or a combination thereof) can be configured in one or more separate integrated circuit devices outside of the integrated circuit package 133 enclosing the passive neural network 105 and the image sensor 113.

The active components 131 can be powered by a battery pack 120 and connected to a communication device 107 and a display device 109. The battery pack 120 can also power the display device 109 and the communication device 107.

For example, the communication device 107 can be used for a wireless connection 121 to a nearby computing device 123, or a remote server computer system 127, or both, for augmented reality based on the images processed by the passive neural network 105.

For example, information about an object recognized from an image processed by the passive neural network 105 can be presented on the display device 109 that is configured on a pair of augmented reality glasses 100. Thus, the reality as seen through the glasses 100 can be augmented by the information about the object presented via the display device 109.

In some implementations, a light of a monochromatic plane wave is used to illuminate a scene. The light as reflected by objects in the scene can be directed by the image generating device 103 to form an image of light pattern incident on an outermost layer of meta neurons of the passive neural network 105. The light of the image can propagate through the meta neurons of the passive neural network 105 to generate a light pattern as an output of the passive neural network 105. The image sensor 113 can convert the light pattern into digital data for further processing by the active components 131.

The image generating device 103 can include a light filter to prevent lights from other sources from entering the passive neural network 105.

In other implementations, an image sensor is used to capture an image of a scene without requiring the use of a controlled light source to illuminate the scene. Based on the captured image, the image generating device 103 can generate an image with wave properties suitable for processing by the passive neural network 105, and direct the generated image on the outermost layer of meta neurons of the passive neural network 105. The light in the generated image can propagate through the passive neural network 105 to generate an output light pattern. The image sensor 113 measures the output light pattern to generate data for further processing by the processor 111 according to artificial neurons.

The use of the passive neural network 105 to implement a portion of the computations of an artificial neural network of the augmented reality application can reduce the energy consumption by the computing unit 101 and improve the energy performance supported by the battery pack 120.

Further, in some implementations, the output of the passive neural network 105 can be used to control the activities of the active components 131 during the monitoring of a scene to detect an object of interest, as in FIG. 3.

FIG. 3 illustrates the processing of an image using a passive neural network configured according to one embodiment. For example, the technique of FIG. 3 can be implemented in the computing unit 101 of FIG. 2 and FIG. 1.

In FIG. 3, image light 201 (e.g., from an image generating device 103) incident on an outermost layer of meta neurons of a passive neural network 105 can propagate through the passive neural network 105 to generate a light pattern 202 without draining the power of a power supply (e.g., battery pack 120).

The passive neural network 105 is configured according to layers of artificial neurons to extract features from the image formed by the light 201. The light pattern 202 is representative of data identifying the features extracted by the passive neural network 105.

An array of light sensing pixels 203 (e.g., configured in an image sensor 113) can convert the light pattern 202 to neuron outputs 205 that are the data representative of the features extracted by the passive neural network 105 from the image light 201. Each pixel in the light sensing pixels 203 can be positioned to measure the light in a respective area in the pattern 202. One of the areas in the light pattern 202 is configured to output an interest level indicator 251 generated via an output meta neuron; and a corresponding pixel 231 is configured to measure the light in the area to provide a neuron output configured as an interest level indicator 251. Other areas of the light pattern 202 provide image feature data 253 configured to be measured via image feature pixels 233 in the light sensing pixels 203.

The output of the interest level pixel 231, generated by the passive neural network 105 responsive to the image light 201, can be used as an interest level indicator 251 to control the power manager 207 in powering the operations of image feature pixels 233, or the processor 111, or both.

For example, when the interest level indicator 251 is below a threshold, the power manager 207 can operate the processor 111 and the image features 233 in a low power mode (e.g., a power off mode, a sleep mode, a hibernation mode). Thus, before the interest level indicator 251 reaches the threshold, the system can use the passive neural network 105 to monitor the image light 201 with reduced or minimized energy expenditure. When an object of interest enters the scene having the image light 201, the interest level indicator 251 can be above the threshold, causing the power manager 207 to power up the processor 111 and the operations of image feature pixels 233 for further analysis of the neuron outputs 205 using further artificial neurons implemented via weight matrices 209 and instructions 211 stored in the memory 115.

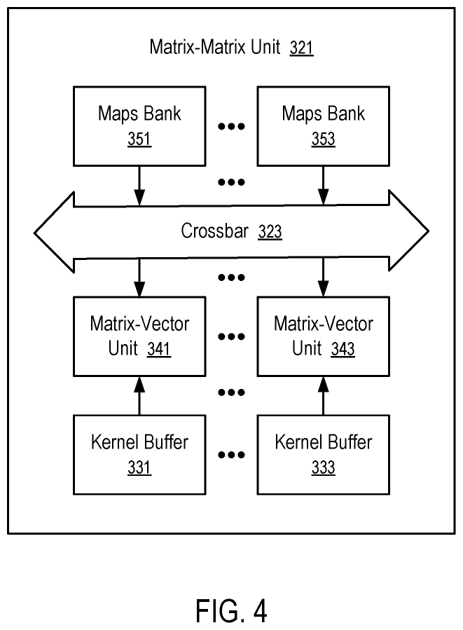

Optionally, a digital multiplication and accumulation accelerator 119 can be used to accelerate the computations of multiplication and accumulation involving the weight matrices 209. The digital multiplication and accumulation accelerator 119 can have processing units configured to execute instructions having matrix operands, and vector operands, as in FIG. 4 to FIG. 6.

FIG. 4 shows a processing unit 321 configured to perform matrix-matrix operations according to one embodiment. For example, the digital multiplication and accumulation accelerator 119 of the computing unit 101 of FIG. 1 and FIG. 2 can be configured with the matrix-matrix unit 321 of FIG. 4.

In FIG. 4, the matrix-matrix unit 321 includes multiple kernel buffers 331 to 333 and multiple maps banks 351 to 353. Each of the maps banks 351 to 353 stores one vector of a matrix operand that has multiple vectors stored in the maps banks 351 to 353 respectively; and each of the kernel buffers 331 to 333 stores one vector of another matrix operand that has multiple vectors stored in the kernel buffers 331 to 333 respectively. The matrix-matrix unit 321 is configured to perform multiplication and accumulation operations on the elements of the two matrix operands, using multiple matrix-vector units 341 to 343 that operate in parallel.

A crossbar 323 connects the maps banks 351 to 353 to the matrix-vector units 341 to 343. The same matrix operand stored in the maps bank 351 to 353 is provided via the crossbar 323 to each of the matrix-vector units 341 to 343; and the matrix-vector units 341 to 343 receives data elements from the maps banks 351 to 353 in parallel. Each of the kernel buffers 331 to 333 is connected to a respective one in the matrix-vector units 341 to 343 and provides a vector operand to the respective matrix-vector unit. The matrix-vector units 341 to 343 operate concurrently to compute the operation of the same matrix operand, stored in the maps banks 351 to 353 multiplied by the corresponding vectors stored in the kernel buffers 331 to 333. For example, the matrix-vector unit 341 performs the multiplication operation on the matrix operand stored in the maps banks 351 to 353 and the vector operand stored in the kernel buffer 331, while the matrix-vector unit 343 is concurrently performing the multiplication operation on the matrix operand stored in the maps banks 351 to 353 and the vector operand stored in the kernel buffer 333.

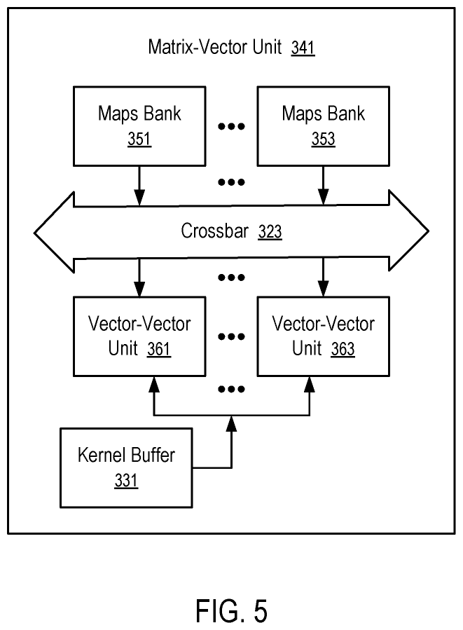

Each of the matrix-vector units 341 to 343 in FIG. 4 can be implemented in a way as illustrated in FIG. 5.

FIG. 5 shows a processing unit 341 configured to perform matrix-vector operations according to one embodiment. For example, the matrix-vector unit 341 of FIG. 5 can be used as any of the matrix-vector units in the matrix-matrix unit 321 of FIG. 4.

In FIG. 5, each of the maps banks 351 to 353 stores one vector of a matrix operand that has multiple vectors stored in the maps banks 351 to 353 respectively, in a way similar to the maps banks 351 to 353 of FIG. 4. The crossbar 323 in FIG. 5 provides the vectors from the maps banks 351 to the vector-vector units 361 to 363 respectively. A same vector stored in the kernel buffer 331 is provided to the vector-vector units 361 to 363.

The vector-vector units 361 to 363 operate concurrently to compute the operation of the corresponding vector operands, stored in the maps banks 351 to 353 respectively, multiplied by the same vector operand that is stored in the kernel buffer 331. For example, the vector-vector unit 361 performs the multiplication operation on the vector operand stored in the maps bank 351 and the vector operand stored in the kernel buffer 331, while the vector-vector unit 363 is concurrently performing the multiplication operation on the vector operand stored in the maps bank 353 and the vector operand stored in the kernel buffer 331.

When the matrix-vector unit 341 of FIG. 5 is implemented in a matrix-matrix unit 321 of FIG. 4, the matrix-vector unit 341 can use the maps banks 351 to 353, the crossbar 323 and the kernel buffer 331 of the matrix-matrix unit 321.

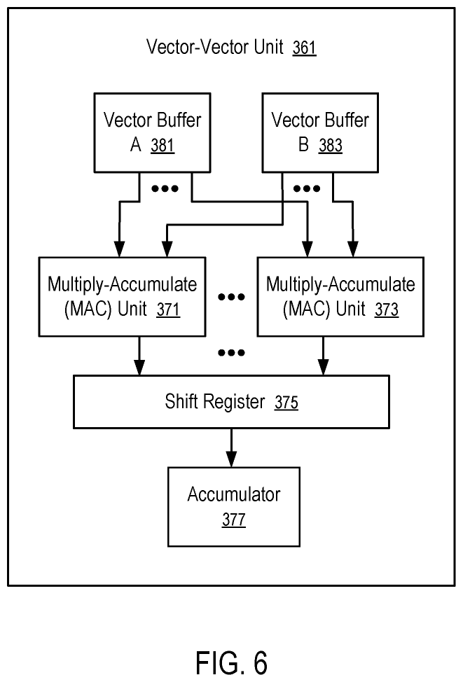

Each of the vector-vector units 361 to 363 in FIG. 5 can be implemented in a way as illustrated in FIG. 6.

FIG. 6 shows a processing unit 361 configured to perform vector-vector operations according to one embodiment. For example, the vector-vector unit 361 of FIG. 6 can be used as any of the vector-vector units in the matrix-vector unit 341 of FIG. 5.

In FIG. 6, the vector-vector unit 361 has multiple multiply-accumulate (MAC) units 371 to 373. Each of the multiply-accumulate (MAC) units 371 to 373 can receive two numbers as operands, perform multiplication of the two numbers, and add the result of the multiplication to a sum maintained in the multiply-accumulate (MAC) unit.

Each of the vector buffers 381 and 383 stores a list of numbers. A pair of numbers, each from one of the vector buffers 381 and 383, can be provided to each of the multiply-accumulate (MAC) units 371 to 373 as input. The multiply-accumulate (MAC) units 371 to 373 can receive multiple pairs of numbers from the vector buffers 381 and 383 in parallel and perform the multiply-accumulate (MAC) operations in parallel. The outputs from the multiply-accumulate (MAC) units 371 to 373 are stored into the shift register 375; and an accumulator 377 computes the sum of the results in the shift register 375.

When the vector-vector unit 361 of FIG. 6 is implemented in a matrix-vector unit 341 of FIG. 5, the vector-vector unit 361 can use a maps bank (e.g., 351 or 353) as one vector buffer 381, and the kernel buffer 331 of the matrix-vector unit 341 as another vector buffer 383.

The vector buffers 381 and 383 can have a same length to store the same number/count of data elements. The length can be equal to, or the multiple of, the count of multiply-accumulate (MAC) units 371 to 373 in the vector-vector unit 361. When the length of the vector buffers 381 and 383 is the multiple of the count of multiply-accumulate (MAC) units 371 to 373, a number of pairs of inputs, equal to the count of the multiply-accumulate (MAC) units 371 to 373, can be provided from the vector buffers 381 and 383 as inputs to the multiply-accumulate (MAC) units 371 to 373 in each iteration; and the vector buffers 381 and 383 feed their elements into the multiply-accumulate (MAC) units 371 to 373 through multiple iterations.

In one embodiment, the communication bandwidth of the interconnect 117 between the accelerator 119 and the memory 115 is sufficient for the matrix-matrix unit 321 to use portions of the memory 115 as the maps banks 351 to 353 and the kernel buffers 331 to 333.

In another embodiment, the maps banks 351 to 353 and the kernel buffers 331 to 333 are implemented in a portion of the local memory of the accelerator 119. The communication bandwidth of the interconnect 117 between the accelerator 119 and the memory 115 sufficient to load, into another portion of the local memory, matrix operands of the next operation cycle of the matrix-matrix unit 321, while the matrix-matrix unit 321 is performing the computation in the current operation cycle using the maps banks 351 to 353 and the kernel buffers 331 to 333 implemented in a different portion of the local memory of the accelerator 119.

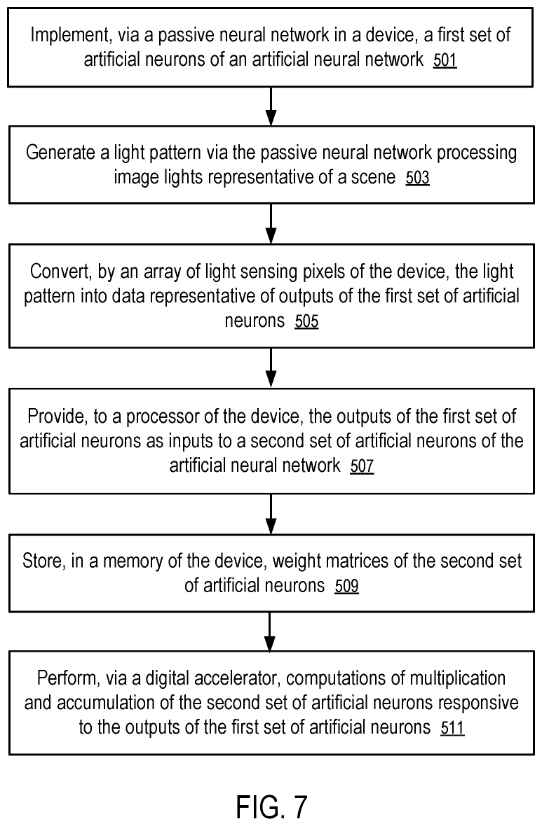

FIG. 7 shows a method of augmented reality according to one embodiment. For example, the method of FIG. 7 can be implemented in a computing unit 101 of FIG. 1 and FIG. 2.

For example, the method of claim 7 can be implemented in an apparatus having a pair of glasses 100 and a computing unit 101 for augmented reality applications via an artificial neural network partially implemented via a passive neural network 105 and partially implemented via digital circuits.

For example, the passive neural network 105 can have cells of photonic crystals or metamaterials configured according to a first set of artificial neurons of the artificial neural network. The artificial neural network can be trained to analyze an image of a scene for object recognition. The first set of artificial neurons of the artificial neural network can be trained to extract features from the image for further analysis by a second set of artificial neurons. The passive neural network 105 can generate a light pattern 202 from image lights 201 propagating through the cells of photonic crystals or metamaterials. An image sensor 113 can convert the light pattern 202 into data representative of features extracted by the first set of artificial neurons from the image lights 201. Logic circuits (e.g., processor 111 and accelerator 119) can be via instructions to perform computations of the second set of artificial neurons of the artificial neural network, responsive to the features as inputs, in recognition of an object of interest in a scene represented by the image lights 201.

At block 501, the first set of artificial neurons of the artificial neural network is implemented via the passive neural network 105 in a device (e.g., computing unit 101, augmented reality glasses 100).

For example, the passive neural network 105 can include cells of photonic crystals or metamaterials configured to interact with the image lights 201 in accordance with the first set of artificial neurons.

At block 503, the light pattern 202 is generated via the passive neural network 105 processing image lights 201 representative of a scene.

For example, a monochromatic plane wave can be provided to illuminate the scene and rebound from objects in the scene to form the image lights 201. The image lights 201 can propagate through the cells of photonic crystals or metamaterials in the passive neural network 105 to form light pattern 202 without applying additional energy to the passive neural network 105. The light pattern 202 represents features extracted from an image representative of the scene via the image lights 201 propagating through the cells of photonic crystals or metamaterials.

At block 505, an array of light sensing pixels 203 of the device converts the light pattern 202 into data representative of outputs 205 of the first set of artificial neurons.

Optionally, the light sensing pixels 203 includes a first portion (e.g., an interest level pixel 231) configured to measure a predetermined area of the light pattern 202 to provide an interest level indicator 251. When the interest level indicator 251 is below a threshold, a portion of the active components 131 powered by a battery pack 120 can be in a low power mode (e.g., in a sleep mode, a hibernation mode, or a power off mode). Thus, the passive neural network 105 can be used to monitor a scene with reduced energy expenditure until the interest level indicator 251 is above a threshold (or when the user of the device explicitly requests an analysis of the scene).

For example, the light sensing pixels 203 can include a second portion (e.g., image feature pixels 233) configured to measure other areas of the light pattern 202 to determine image feature data 253 extracted by the passive neural network 105. When the interest level indicator 251 is below the threshold, the image feature pixels 233 can be inactive and thus not generating the image feature data 253.

At block 507, a processor 111 of the device is provided with the outputs 205 of the first set of artificial neurons as inputs to the second set of artificial neurons of the artificial neural network.

For example, when the interest level indicator 251 is above the threshold, the power manager 207 of the device can activate the image feature pixels 233 to generate the image feature data 253 for further analysis by the processor 111.

At block 509, a memory 115 of the device stores weight matrices 209 of the second set of artificial neurons.

At block 511, a digital accelerator 119 of the device performs computations of multiplication and accumulation of the second set of artificial neurons responsive to the outputs 205 of the first set of artificial neurons.

For example, the processor 111 and the digital accelerator 119 can be configured via the instructions 211 to perform the computations of the second set of artificial neurons to recognize an object in the scene, and present information about the object in response to recognition of the object. The digital accelerator 119 can include processing units, such as matrix-matrix unit 321, matrix-vector units 341, and vector-vector units 361 to execute instructions having matrix and vector operands.

For example, the information can be overlain on the pair of glasses 100 to augment the view through the glasses 100. Alternatively, the information can be projected via the glasses 100 to the eyes of the user of the glasses 100.

Optionally, the device includes a wireless transceiver (e.g., communication device 107) configured to communicate with a computing device 123 and/or a server computer system 127 to retrieve the information based on the outputs of the second set of artificial neurons.

The memory 115 can be a memory sub-system having media, such as one or more volatile memory devices (e.g., memory device), one or more non-volatile memory devices (e.g., memory device), or a combination of such. The memory sub-system can be coupled to a host system (e.g., having a processor 111) in a computing system (e.g., as in FIG. 1 and FIG. 2). As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

A memory sub-system can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The host system can include a processor chipset (e.g., processing device) and a software stack executed by the processor chipset. The processor chipset can include one or more cores, one or more caches, a memory controller (e.g., controller) (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. FIG. 11 illustrates a memory sub-system as an example. In general, the host system can access multiple memory sub-systems via a same communication connection, multiple separate communication connections, and/or a combination of communication connections.

The processing device of the host system can be, for example, a microprocessor, a central processing unit (CPU), a processing core of a processor, an execution unit, etc. In some instances, the controller can be referred to as a memory controller, a memory management unit, and/or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller and/or the processing device can include hardware such as one or more integrated circuits (ICs) and/or discrete components, a buffer memory, a cache memory, or a combination thereof. The controller and/or the processing device can be a microcontroller, special purpose logic circuitry (e.g., a field programmable gate array (FPGA), an application specific integrated circuit (ASIC), etc.), or another suitable processor.

The memory devices can include any combination of the different types of non-volatile memory components and/or volatile memory components. The volatile memory devices (e.g., memory device) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs) and/or discrete components, a buffer memory, or a combination thereof. The hardware can include digital circuitry with dedicated (i.e., hard-coded) logic to perform the operations described herein. The controller can be a microcontroller, special purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system in FIG. 11 has been illustrated as including the controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local controller (e.g., local controller) for media management within the same memory device package. An example of a managed memory device is a managed NAND (MNAND) device.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a pair of glasses; and
a computing unit, having:
a passive neural network configured to process image lights representative of a scene in a view of the pair of glasses to generate a light pattern;
an array of light sensing pixels configured to convert the light pattern into data representative of outputs of a first set of artificial neurons implemented by the passive neural network;
a processor configured via instructions to perform computations of a second set of artificial neurons responsive to the outputs of the first set of artificial neurons; and
a digital accelerator configured to accelerate multiplication and accumulation operations of weight matrices of the second set of artificial neurons.

2. The apparatus of claim 1, further comprising:
a memory configured to store the instructions and the weight matrices.

3. The apparatus of claim 2, wherein an artificial neural network containing the first set of artificial neurons and the second set of artificial neurons is configured to recognize an object in the scene; and the apparatus is configured to present information about the object in response to recognition of the object.

4. The apparatus of claim 3, wherein the passive neural network includes cells of photonic crystals or metamaterials configured to interact with the image lights in accordance with the first set of artificial neurons.

5. The apparatus of claim 4, further comprising:
a battery pack configured to power the processor in response to an output of the first set of artificial neurons exceeding a threshold.

6. The apparatus of claim 5, wherein the processor and a portion of the light sensing pixels are configured in a low power mode before the output exceeding the threshold.

7. The apparatus of claim 6, wherein the outputs of the first set of artificial neurons are configured to be representative of features extracted from an image representative of the scene.

8. The apparatus of claim 7, wherein the image lights are a monochromatic plane wave rebounded from objects in the scene.

9. The apparatus of claim 8, further comprising:
a display device integrated with the pair of glasses and configured to present the information.

10. The apparatus of claim 9, further comprising:
a wireless transceiver configured to communicate with a computing device to retrieve the information.

11. A method, comprising:
implementing, via a passive neural network in a device, a first set of artificial neurons of an artificial neural network;
generating a light pattern via the passive neural network processing image lights representative of a scene;
converting, by an array of light sensing pixels of the device, the light pattern into data representative of outputs of the first set of artificial neurons;
providing, to a processor of the device, the outputs of the first set of artificial neurons as inputs to a second set of artificial neurons of the artificial neural network;
storing, in a memory of the device, weight matrices of the second set of artificial neurons; and
performing, via a digital accelerator, computations of multiplication and accumulation of the second set of artificial neurons responsive to the outputs of the first set of artificial neurons.

12. The method of claim 11, further comprising:
recognizing, using the artificial neural network, an object in the scene; and
presenting information about the object in response to recognition of the object.

13. The method of claim 12, wherein the passive neural network includes cells of photonic crystals or metamaterials configured to interact with the image lights in accordance with the first set of artificial neurons.

14. The method of claim 13, further comprising:
powering, by a battery pack, the processor in response to an output of the first set of artificial neurons exceeding a threshold.

15. The method of claim 14, further comprising:
operating the processor and a portion of the light sensing pixels in a low power mode before the output exceeding the threshold.

16. The method of claim 15, further comprising:
providing a monochromatic plane wave to be rebounded from objects in the scene to receive the image lights;
extracting features from an image representative of the scene via the image lights propagating through the cells of photonic crystals or metamaterials to form the light pattern.

17. A computing device, comprising:
a passive neural network having cells of photonic crystals or metamaterials configured according to a first set of artificial neurons of an artificial neural network to generate a light pattern from image lights propagating through the cells;
an image sensor configured to convert the light pattern into data representative of features extracted by the first set of artificial neurons from the image lights; and
logic circuits configured via instructions to perform computations of a second set of artificial neurons of the artificial neural network, responsive to the features as inputs, in recognition of an object of interest in a scene represented by the image lights.

18. The computing device of claim 17, wherein the logic circuits include a digital accelerator configured to accelerate multiplication and accumulation operations applied on weight matrices of the second set of artificial neurons.

19. The computing device of claim 18, wherein the image sensor includes a first portion configured to provide an interest level indicator; and the logic circuits are configured in a low power mode when the interest level indicator is below a threshold.

20. The computing device of claim 19, wherein the image sensor includes a second portion configured to be inactive in generating outputs when the interest level indicator is below a threshold.
